(19) United States
(12) Patent Application Publication
(10) Pub. No.: US 2026/0316021 A1
(43) Pub. Date: Oct. 15, 2026

(54) SHAFTLESS BLENDING CONTAINERS

(71) Applicant: Vita-Mix Management Corporation, Olmsted Township, OH (US)

(72) Inventors: Mark Mayer, Sagamore Hills, OH (US); David Kolar, Olmsted Township, OH (US); Kyle Jones, Olmsted Township, OH (US); Thomas Clynne, Lakewood, OH (US); Brad Paskert, Strongsville, OH (US)

(73) Assignee: Vita-Mix Management Corporation, Olmsted Township, OH (US)

(21) Appl. No.: 19/485,527

(22) PCT Filed: May 17, 2024
(86) PCT No.: PCT/US2024/029921

§ 371 Date: Nov. 18, 2025

Related U.S. Application Data
(60) Provisional application No. 63/467,690, filed on May 19, 2023.

(51) Int. Cl. B01F 27/051; B01F 27/072

(52) U.S. Cl. CPC B01F 27/051; B01F 27/072

(57) ABSTRACT

A blending container is disclosed. The blending container includes a body including a continuous base and a sidewall extending from the continuous base. The continuous base and the sidewall define a reservoir for receiving contents therein. The blending container further includes a blade positioned on or adjacent to the sidewall of the body.

### CROSS-REFERENCE TO RELATED APPLICATION

The present application claims priority to and the benefit of U.S. Provisional Application No. 63/467,690, entitled SHAFTLESS BLENDING CONTAINERS, and filed on May 19, 2023, the entire contents of which are hereby incorporated by reference.

### TECHNICAL FIELD

The present teachings relate to a blending system and blending containers, and more particularly, to a blending system and blending containers that do not include a blade shaft.

### BACKGROUND

Mixing systems and blending systems are often used to blend and process contents in various settings. For example, such mixing and/or blending systems are used to blend foodstuffs in a kitchen setting or biological matter in a laboratory or clinical setting. Conventional blenders generally include a base with a motor and a container with an operable mixing blade and blade assembly disposed therein. A blender lid is adapted to selectively cover the container. A user inserts contents within the container to be mixed by the rotation of the mixing blade. The container is selectively positioned on the base as a user controls the operation of the motor within the base to rotate the mixing blade within the container to mix the contents therein. A drive or blade shaft operatively couples the blade assembly with the motor and causes a rotation of the blade in the container as the blade shaft is driven by the motor.

Conventional blending systems generally require a container that is attachable to a base or motor housing at a “closed end” of the container and that includes a blade and blade assembly within the “closed end” of the container to facilitate blending of the contents therein. Due to the rotational operation of the blade assembly that is driven by a shaft or other driver component that selectively couples with the base and/or motor, the “closed end” is not hermetically sealed. Conventional blender containers generally include a rotating blade assembly, shaft, bearings, and seals.

The need for seals can be costly to add and difficult to attach during assembly. Such seals can shorten the life of the blending containers, can result in fluid or other contents undesirably exiting the container and entering the base or motor housing that can make cleaning more difficult, can increase the time and resources required to clean blending systems using the blending containers, and the like. For blending systems and blending containers used in biomedical applications, such leakage is unsanitary and can be considered a hazard or biohazard, for example.

### SUMMARY

Additional features and advantages of the present disclosure will be set forth in the detailed description, which follows, and in part will be apparent to those skilled in the art from that description or recognized by practicing the embodiments described herein, including the detailed description, which follows the claims, as well as the appended drawings.

In at least one instance, a blending container is disclosed. The blending container includes a body including a continuous base and a sidewall extending from the continuous base. The continuous base and the sidewall define a reservoir for receiving contents therein. The blending container further includes a blade positioned on or adjacent to the sidewall of the body.

In at least one instance, a blending container is disclosed. The blending container includes a body including a closed base and a sidewall extending from the closed base. The closed base and the sidewall define a reservoir for receiving contents therein, wherein the sidewall includes an interior surface. The blending container further includes a plurality of blades positioned adjacent to the interior surface of the sidewall.

In at least one instance, a blending assembly is disclosed. The blending assembly includes a blending container including a base, the base being closed, and a sidewall extending from the base. The base and the sidewall define a reservoir to support contents therein. The blending container further includes a plurality of blades positioned adjacent the sidewall of the body. The blending assembly further includes an attachment mechanism for supporting the blending container in a desired orientation during a blending process.

In at least one instance, a blending container is disclosed. The blending container includes a body including a closed base and a sidewall extending from the closed base. The closed base and the sidewall define a reservoir for receiving contents therein. The blending container further includes a plurality of blades, wherein each of the plurality of blades extend into the reservoir from the sidewall of the body.

In at least one instance, a blending container is disclosed. The blending container includes a body including a closed base and a sidewall extending from the closed base. The closed base and the sidewall define a reservoir for receiving contents therein. The blending container further includes a mandrel positioned in the reservoir of the body, the mandrel including a plurality of blades positioned thereon.

In at least one instance, a blending container is disclosed. The blending container includes a body including a closed base and a sidewall extending from the closed base. The closed base and the sidewall define a reservoir for receiving contents therein, wherein the sidewall includes an interior surface. The blending container further includes a blade column positioned in the reservoir of the body, the blade column including a plurality of blades defined thereon.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description, explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of a blending container including a blade assembly and a drive or blade shaft.

FIG. 2 is a perspective view of an illustrative shaftless blending container according to one or more aspects shown and described herein.

FIG. 3 is a side view of the shaftless blending container of FIG. 2.

FIG. 4 is a top view of an illustrative reservoir defined within the shaftless blending container of FIG. 2.

FIG. 5 is a perspective view of an illustrative motor base for use with a shaftless blending container according to one or more aspects shown and described herein.

FIG. 6 is a perspective view of an illustrative shaftless blending container having a narrowed opening according to one or more aspects shown and described herein.

FIG. 7 is a top view of an illustrative reservoir defined within the shaftless blending container of FIG. 6.

FIG. 8 is a side view of the shaftless blending container of FIG. 6 including mixed contents therein according to one or more aspects shown and described herein.

FIG. 9 is a perspective view of an illustrative shaftless blending container showing a mandrel having a plurality of blades positioned therein according to one or more aspects shown and described herein.

FIG. 10 is a perspective view of the mandrel of FIG. 9.

FIG. 11 is a perspective view of an illustrative shaftless blending container showing a blade column positioned therein according to one or more aspects shown and described herein.

FIG. 12 is a perspective view of the blade column of FIG. 11 in an unfolded configuration according to one or more aspects shown and described herein.

FIG. 13 is a perspective view of the blade column of FIG. 11 in a folded configuration according to one or more aspects shown and described herein.

FIG. 14 is a perspective view of an illustrative attachment mechanism to support a shaftless blending container on a blending base according to one or more aspects shown and described herein.

FIG. 15 is a perspective view of the attachment mechanism of FIG. 14 coupled to a blending base according to one or more aspects shown and described herein.

The present disclosure may be embodied in several forms without departing from its spirit or essential characteristics. The scope of the present disclosure is defined in the appended claims, rather than in the specific description preceding them. All embodiments that fall within the meaning and range of equivalency of the claims are therefore intended to be embraced by the claims.

### DETAILED DESCRIPTION

Reference will now be made in detail to embodiments of the present teachings, examples of which are illustrated in the accompanying drawings. Whenever possible, the same reference numerals will be used throughout the drawings to refer to the same or like parts. The present disclosure generally relates to shaftless blending containers including one or more blades positioned within a reservoir defined by a base and a sidewall of a particular shaftless blending container. In various instances, the one or more blades are positioned adjacent the sidewall of the particular shaftless blending container. The one or more blades can be supported within the reservoir of the shaftless blending container in various manners, such as an individual blade being embedded within the sidewall, a mandrel, extending into the reservoir, having the one or more blades positioned thereon, and/or a blade column, extending into the reservoir, having the one or more blades defined thereon, for example.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It is noted that blending systems and blending containers may be used in laboratory, or biomedical applications, for example, such as being used for tumor biopsies. In laboratory settings, for example, the contents of the blending systems and blending containers may include biological materials (e.g., tumor cells, tissues, bodily fluids, etc.). While blending of “ingredients,” “contents,” or “foodstuffs” is described by various embodiments, it is noted that non-food stuff may be mixed or blended, such as biological materials, paints, epoxies, construction material (e.g., mortar, cement, etc.), and the like. Moreover, blending of ingredients may result in a blended product. In the context of foodstuffs, such blended products may include drinks, frozen drinks, smoothies, shakes, soups, purees, salsas, sauces, sorbets, butters or milks (e.g. nut or oat), dips or the like. In the context of biological matter, such blended products may include a mixed suspension including tissue and/or tumor cells and a fluid solution, for example. Accordingly, such terms may be used interchangeably unless context suggests otherwise or warrants a particular distinction among such terms. Further, such terms are not intended to limit possible blended products and should be viewed as examples of possible blended products.

As used herein, the phrases “blending process,” “blending program,” and the like are used interchangeably unless context suggest otherwise or warrants a particular distinction among such terms. A blending process may include a series or sequence of blender settings and operations to be carried out by the blending device. In an aspect, a blending process may include at least one motor speed and at least one time interval for the given motor speed. For example, a blending process may include a plurality of blender motor speeds to operate the blender blade at the given speed, a series of time intervals corresponding to the given motor speeds, and other blender parameters and timing settings. The blending process may further include a ramp up speed that defines the amount of time the motor takes to reach its predetermined motor speed. The blending process may be stored on a memory and recalled by or communicated to the blending device.

Embodiments disclosed herein relate to test tube blender systems and methods, cup blender systems and methods, large format blending systems and methods, and the like. Such test tube blender systems are operatively utilized to mix or blend contents within a test tube, a centrifuge tube, or other vessel in which a user may blend contents in a laboratory, or clinical, setting. In such instances, the blended product may remain in the test tube or centrifuge tube after the blending process is performed for further testing and/or analysis, for example. Such cup blender systems are operatively utilized to mix or blend contents within a cup or other vessel in which a user may consume a blended product. Larger format blending systems may include household blenders, commercial blenders, food processors, or the like, and may generally include a blending vessel for foodstuff wherein the blended foodstuff is thereafter transferred to a different container for consuming. These containers may come in different sizes (e.g., single serving, pitchers, etc.) but may be designed to assist in the fluid dynamics of larger format blending systems, e.g., tapered sidewalls that increase in diameter towards a rim, one or more ribs that protrude into an interior of the container, etc.

Disclosed are blending systems and blending containers that do not include a blade shaft. As such, the disclosed blending systems and blending containers do not include components such as bearings, seals, and other components that may be typically used with a blade shaft. The blending systems and blending containers described herein include a continuous surface at one end of the container, e.g., the bottom or closed end. In an embodiment, the blending systems and blending containers provide a hermetic seal at one end of the container, e.g., the bottom or closed end.

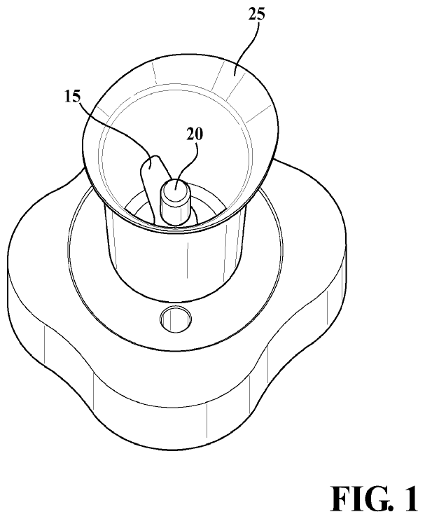

FIG. 1 depicts a blending container 25 and blade assembly 15 with a drive or blade shaft 20. The blade assembly 15 includes two or more blades that are mounted on, or otherwise coupled to, the blade shaft 20. The blade assembly 15 may be positioned within a reservoir defined by a sidewall and a base of the blending container 25. The blade assembly 15 may be used to blend contents supported within the reservoir of the blending container 25. The blade shaft 20 is rotatably driven by an output of a motor. Such an output of the motor drives the blade shaft 20 and causes the blade assembly 15 to turn within the reservoir, thereby facilitating a blending process.

In these systems, the motor operatively couples and functions with the blade assembly 15. Notably, the motor is traditionally mounted, or otherwise housed, outside of, or remote to, the blending container 25. For example, the motor can be housed in a separate motor housing or base. Such remote positioning of the motor relative to the blade shaft requires that the blade shaft 20, or component related to the blade shaft 20, extend through a body of the blending container 25, such as the bottom of the blending container 25 (e.g., at the “closed end” of the container) for motors housed in a base positioned beneath the blending container 25.

The blade shaft 20 and related components selectively couple the motor and the blade assembly 15 so that an output of the motor may drive the blade shaft 20, thereby causing the blade assembly 15 to rotate, or spin, within the blending container 25. This typically utilizes bearings and seals in the blending container 25 or around the blade assembly 15 and blade shaft 20 to attempt to keep liquid and foodstuff from leaking through or around the seals and blade shaft 20. Utilizing such seals may lead to reduced performance and like of the blending device. Such seals may further limit washing and sanitation of the blending container 25 (e.g., the blending container 25 may not be dishwasher safe or may not allow for soaking in water) as well as reduce the lifetime of the blending container 25 as the seals wear over time.

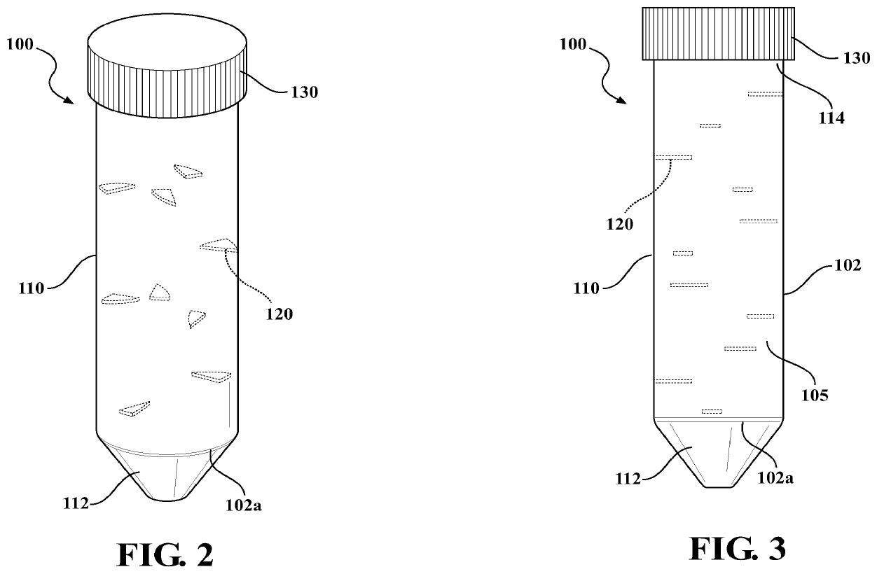

FIGS. 2-4 depict a shaftless blending container 100. The shaftless blending container 100 is distinctly different than the blending container 25 shown in FIG. 1, as the shaftless blending container 100 does not include a blade shaft and a blade assembly, for example. In various instances, the shaftless blending container can be a test tube or a centrifuge tube, for example. The shaftless blending container 100 includes a body 110 defined by a base 112, or closed end, and a sidewall 102 extending from the base 112. In various instances, as depicted in FIGS. 2-4, an interface between the sidewall 102 and the base 112 is continuous. Stated another way, the sidewall 102 and the base 112 are integrally formed with one another, and no seams exist between the two components. In other instances, a seam exists between the sidewall 102 and the base 112. In at least one instance, the base 112 of the shaftless blending container 100 may be hermetically sealed.

The sidewall 102 includes a first end 102a that couples to the base 112 and a second, opposing end 102b that defines an opening 114. Contents for blending and/or mixing are to be inserted through the opening 114 where the contents are then supported within a reservoir 105 defined by the sidewall 102 and the base 112. The shaftless blending container 100 further includes a lid 130, or cap, that is selectively, or removably, attachable to the second end of the sidewall 102 to maintain a sanitary environment within the reservoir 105 and/or to prevent the contents stored within the shaftless blending container 100 from leaking, or otherwise escaping, out of the opening 114, for example. In various instances, the shaftless blending container 100 may have no openings other than the opening 114 of the shaftless blending container 100. For example, the shaftless blending container 100 may be hermetically sealed at the base 112.

The shaftless blending container 100 may be sized and shaped to receive and blend contents for various applications. As such, the shaftless blending container 100 may have a capacity of 1 mL, 5 mL, 10 mL, 15 mL, 20 mL, 50 mL, etc. For example, the shaftless blending container 100 may have a capacity of about 1 to about 50 mL.

As shown in FIGS. 2-4, the body 110 of the shaftless blending container 100 has a generally cylindrical shape. In such instances, the body 110 of the shaftless blending container 100 may have a generally circular lateral or horizontal cross-section. However, it is noted that other shapes and cross-sections of the body 110 are also herein contemplated, including elliptical, cylindrical, circular, pyramidal, squared, rectangular, pentagonal, hexagonal, conical, frustoconical, irregular, symmetrical, asymmetrical, etc., shapes and/or cross-sections. The shaftless blending container 100 may have a generally consistent diameter across the majority of the body 110. In an embodiment, the shaftless blending container 100 may have a variable or differing diameter across the majority of the body 110. As shown in FIGS. 2 and 3, the body 110 of the shaftless blending container 100 includes a tapered base 112. In various instances, the body 110 may taper inwardly or outwardly towards the opening 114. In various instances, the body 110 may taper inwardly or outwardly towards the base 112. In various instances, a central portion of the body 110 of the shaftless blending container 100 may have a different shape and/or cross-section than the base 112 or opening 114.

While the body 110 of the shaftless blending container 100 is depicted as a cylinder in FIGS. 2-4, it is noted that the body 110 may also have any number of sides, such as 1, 2, 3, 4, 5, 6, 7, 8, 9, 10, etc. sides, and may generally adopt the shape of a parallelogram, circle, rectangle, square, portion of any of the foregoing, and/or the like. The sidewall(s) 102 of the body 110 may include any number of flutes or ribs. A sidewall 102, defining a reservoir 105 therein, may be referred to in a singular form or a plural form. Edges and corners of sidewall(s), or portions connecting sidewall(s), may similarly have any number of sides, such as 1, 2, 3, 4, 5, 6, 7, 8, 9, 10, etc. sides, and may generally adopt the shape of a parallelogram, circle, rectangle, square, portion of any of the foregoing, or the like. Although general measurements or indications of height, length, width, distance, thickness, and angles may be disclosed, it is noted that these aspects are broadly defined within this disclosure unless specifically indicated for a particular embodiment.

The shaftless blending container 100 may include a pointed, narrowed, or otherwise tapered base 112. For example, as shown in FIG. 3, the shaftless blending container 100 may include a base 112 that is frustoconical (e.g., conical with a flat tip or a truncated conical shape). For example, as shown in FIG. 3, the base 112 may have a generally circular lateral or horizontal cross-section. The generally circular cross-sections of the base 112 may gradually change in diameter. For example, the generally circular cross-sections of the base 112 may gradually increase in circumference towards the sidewall 102 of the shaftless blending container 100. It is noted that other shapes and cross-sections of the shaftless blending container 100 are also herein contemplated, including elliptical, cylindrical, circular, pyramidal, squared, rectangular, pentagonal, hexagonal, conical, frustoconical, irregular, symmetrical, asymmetrical, etc., shapes and/or cross-sections. For example, the base 112 may be conical (e.g., coming to a point), pyramidal (e.g., having flat side surfaces), rounded, and the like.

The opening 114 of the shaftless blending container 100 is sized to selectively, or removably, receive and engage with the lid 130. As shown in FIGS. 2-4, the opening 114 may be generally circular. In various instances, the opening 114 may have the same general shape as various cross-sections of the body 110 of the shaftless blending container 100. The body 110 of the shaftless blending container 100 adjacent the opening 114 may include threads that are configured to engage with mating threads of the lid 130 to secure the lid 130 to the shaftless blending container 100. In an embodiment, the threads on body 110 of the shaftless blending container 100 adjacent the opening 114 may be located on at or near the opening 114 on an exterior of the body 110 and the mating threads on the lid 130 may be located on an interior of the lid 130, e.g., on a lip of the lid 130. It is noted that the engagement may be of any appropriate configuration and type, including, in an example, snap fit, friction fit, threading, bayonet connectors, other mating protrusions and recesses, or the like. It is further noted that the opening 114 may be narrowed or of such a shape so as to generally contain blended contents within the reservoir 105 of the shaftless blending container 100 so as to prevent the contents supported within the reservoir 105 from leaking, or otherwise flowing out of the opening 114 when the lid 130 is not coupled to the shaftless blending container 100.

The shaftless blending container 100 includes one or more blades 120. In various instances, the shaftless blending container 100 includes five (5) blades or more. For example, the shaftless blending container 100 may include ten (10) blades or more. For example, the shaftless blending container 100 may include fifteen (15) blades or more. For example, the shaftless blending container 100 may include twenty (20) blades or more. For example, the shaftless blending container 100 may include forty (40) blades or more.

As shown in FIGS. 2-4, one or more blades 120 are attached to, partially embedded in, integrated with, or otherwise coupled to an interior surface of the sidewall 102. In various instances, at least a portion of the one or more blades 120 extends into the sidewall 102 of the shaftless blending container 100. In such instances the blades 120 are not intended to extend through, or otherwise beyond, an entire thickness of the sidewall 102. In various instances, one or more apertures are pre-defined in the sidewall 102 of the shaftless blending container 100 and sized to receive the one or more blades 120. In such instances, the one or more blades 120 can be maintained in position due to an interference fit. In various instances, the one or more blades 120 are secured, or otherwise coupled, to a sidewall 102 by use of an adhesive, for example. In any event, the one or more blades 120 are secured to the interior surface 103 of the sidewall 102 such that the blades 120 remain stationary as a blending process is performed.

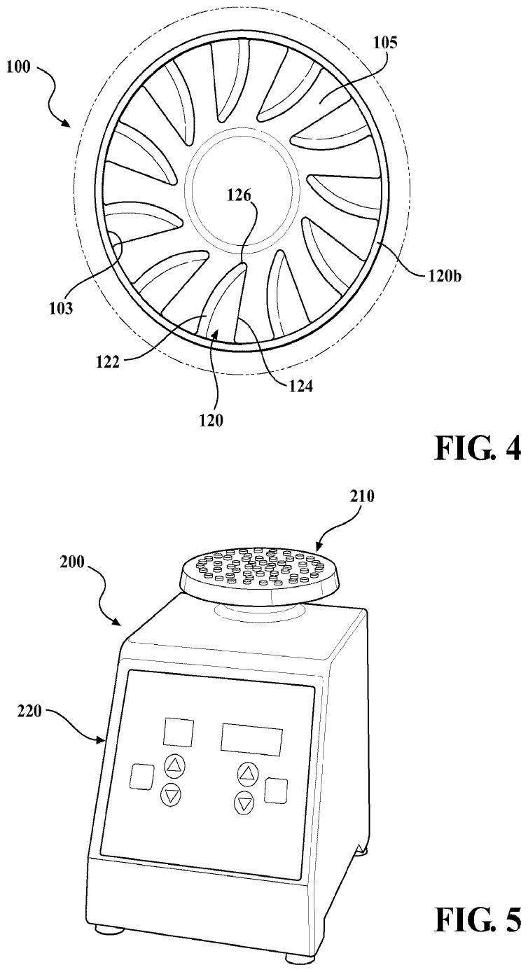

Each of the one or more blades 120 includes a first edge 122 and a second edge 124. The first edge 122 interfaces with the second edge 124 at an interface 126, such as a tip or the like. Such an interface 126 can be sharp or rounded, for example. As shown in FIG. 4, the first edge 122 is generally curved or rounded while the second edge 124 has a generally straight edge. The first edge 122 and the second edge 124 depicted in FIG. 4 mimics the overall geometry of a knife blade, for example. In other instances, the second edge 124 may share the same generally curved or rounded geometry as the first edge 122, for example. Furthermore, in other instances, the first edge 122 may share the same generally straight edge as the second edge 124. The one or more blades 120 can have any suitable geometry to create the desired blended product. For example, the one or more blades 120 may be triangular in shape. It is noted that the one or more blades 120 may be of any other desired shape, including, for example, tapered, angled, and the like. The one or more blades 120 may be oriented in the same direction, as shown in FIG. 4. In various instances, the one or more blades 120 may also be oriented in opposite or different directions. The one or more blades 120 may be the same shape or may be different shapes. The one or more blades 120 may be the same size or different sizes.

The one or more blades 120 may be positioned at any location within the shaftless blending container 100 and in any pattern, for example. In various instances, the one or more blades 120 are positioned throughout the shaftless blending container 100 randomly, or in no apparent pattern. The one or more blades 120 can be oriented in a pattern such as in lines, in a spiral, diagonally, etc. As shown in FIG. 4, for example, the one or more blades 120 may be spaced along the entire circumference of the reservoir 105 of the shaftless blending container 100. In various instances, the one or more blades 120 may be spaced equidistantly around the circumference of the reservoir 105. In other instances, the one or more blades 120 may be spaced unevenly around the circumference of the reservoir 105. The one or more blades 120 are further spaced along an entire length of the reservoir 105 of the shaftless blending container 100. In various instances, the one or more blades 120 may be spaced equidistantly relative to one another along the length of the reservoir 105. In other instances, the one or more blades 120 may be spaced unevenly relative to one another along the length of the reservoir 105 as shown in FIGS. 2 and 3. The one or more blades 120 may further be positioned at any length or height on the body 110 of the shaftless blending container 100, including at or near the opening 114 and/or the base 112.

An exemplary base 200 for use in mixing and/or blending the contents of the shaftless blending container, such as the shaftless blending container 100, is depicted in FIG. 5. The depicted base 200 is a vortex mixer such as, for example, the Vortex-Genie 2 Mixer manufactured by Scientific Industries, Inc. However, other motor bases may also be used with the shaftless blending container 100, including, for example, attachment to a conventional blender base that uses a piston arm to convert rotary motion to an orbital motion. The base includes a mixing platform 210 and a housing 220. The housing 220 supports a motor therein to drive a vibration, vortex, or swirling type movement to the shaftless blending container 100 through the mixing platform 210. The shaftless blending container 100 is configured to contact, or otherwise interact with, the mixing platform. For example, the base 112 of shaftless blending container 100 may be placed on the mixing platform 210. Once the base 112 of the shaftless blending container 100 has made sufficient contact with the mixing platform 210, such as by applying a downward force thereto, the motor of the base is activated, or otherwise engaged. FIG. 5 shows an example of a vortex type mixer that may be used with shaftless blending containers 100.

The shaftless blending container 100 may be agitated in a generally orbital motion with respect to its vertical axis. This orbital agitation may cause the contents of the shaftless blending container to swirl creating a vortex. This vortex may cause the contents to travel at high speed around the reservoir 105 of the shaftless blending container 100. As the contents are spun within the reservoir 105, the contents are moved through, or otherwise interact with, the one or more blades 120 positioned on an interior surface 103 of the sidewall 102 of the shaftless blending container 100 to produce a desired blended product. In various instances, such a desired blended produced is a smooth homogeneous slurry, for example.

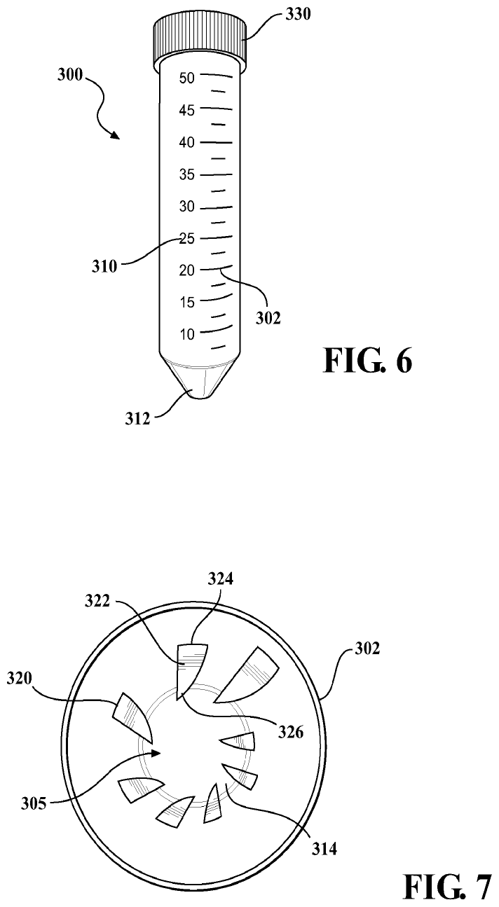

FIGS. 6-8 depict a shaftless blending container 300, similar in many respects to the shaftless blending container 100. In various instances, the shaftless blending container can be a test tube or a centrifuge tube, for example. The shaftless blending container 300 includes a body 310 defined by a base 312, or closed end, and a sidewall 302 extending from the base 312. In various instances, as depicted in FIGS. 6-8, an interface between the sidewall 302 and the base 312 is continuous. Stated another way, the sidewall 302 and the base 312 are integrally formed with one another, and no seams exist between the two components. In other instances, a seam exists between the sidewall 302 and the base 312. In at least one instance, the base 312 of the shaftless blending container 100 may be hermetically sealed.

The sidewall 302 includes a first end that couples to the base 312 and a second, opposing end that defines an opening 314. Contents for blending and/or mixing are inserted through the opening 314 where the contents are then supported within a reservoir 305 defined by the sidewall 302 and the base 312. The shaftless blending container 300 further includes a lid 330, or cap, that is selectively, or removably, attachable to the second end of the sidewall 302 to maintain a sanitary environment within the reservoir 305 and/or to prevent the contents stored within the shaftless blending container 300 from leaking, or otherwise escaping, out of the opening 314, for example. Notably, the opening 314 of the shaftless blending container 300 is different than the opening 114 of the shaftless blending container 100. More specifically, the opening 314 of the shaftless blending container 300 is tapered, or otherwise narrowed, so that the shaftless blending container 300 can be used with and without a lid 330. Stated another way, the tapered opening 314 prevents contents from spilling, or otherwise flowing, out of the opening 314 regardless of whether a lid 330 is coupled to the shaftless blending container 300 or not.

Similarly to the shaftless blending container 100 described hereinabove, the shaftless blending container 300 includes one or more blades 320. The one or more blades 320 are coupled to an interior surface of the sidewall 302 in any suitable manner as described with respect to the one or more blades 120, for example. Each of the one or more blades 320 includes a first edge 322 and a second edge 324. The first edge 322 interfaces with the second edge 324 at an interface 326. Such an interface 326 can be sharp or rounded, for example. As shown in FIG. 7, for example, the first edge 322 and the second edge 324 form a hook-shaped blade.

As discussed herein, the one or more blades 320 can be positioned at any frequency and/or orientation throughout the shaftless blending container 300. As shown in FIG. 6, the one or more blades 320 are shown positioned at graduating or sequential heights, e.g., resulting in a spiral formation.

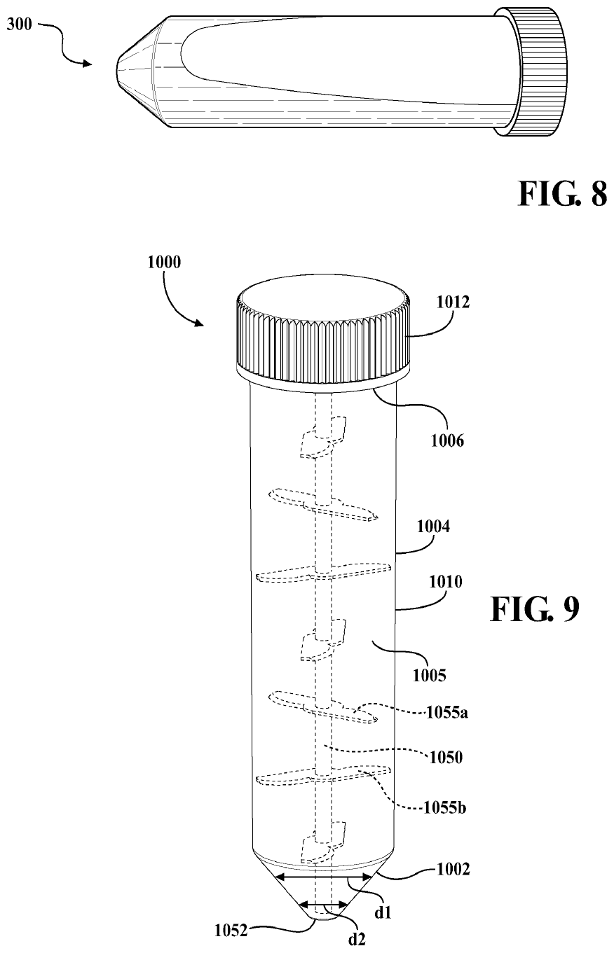

FIG. 8 depicts the results of a blending process where material was orbitally agitated in the shaftless blending container 300 for a period of 40 seconds.

Referring now to FIGS. 9-13, one or more blades may be provided as an insert or adapter that can be used with a shaftless blending container. For example, the shaftless blending container may not include any blades and the insert including one or more blades can be placed into the container. As described herein the one or more blades may be provided, for example, as an attachment coupled to a lid, or cap, for example. In such instances, the one or more blades may be coupled to the lid such that the one or more blades extend into the reservoir of the shaftless blending container. Such an insert may be sized to be used with existing containers and cups, for example.

FIG. 9 shows a shaftless blending container 1000. In various instances, the shaftless blending container can be a test tube or a centrifuge tube, for example. The shaftless blending container 1000 includes a body 1010 defined by a base 1002 and a sidewall 1004 extending from the base 1002. In various instances, an interface between the sidewall 1004 and the base 1002 is continuous. Stated another way, the sidewall 1004 and the base 1002 are integrally formed with one another, and no seams exist between the two components. In other instances, a seam exists between the sidewall 1004 and the base 1002. In at least one instance, the base 1002 of the shaftless blending container 1000 may be hermetically sealed.

In various instances, the base 1002 is tapered. More specifically, the base 1002 comprises a first diameter d1 at a first point and a second diameter d2 at a second point. The first point of the base 1002 is positioned adjacent the first end of the sidewall 1004, whereas the second point of the base 1002 is positioned further away from the first end of the sidewall 1004. The first diameter d1 is different than the second diameter d2, and, as shown in FIG. 9, the first diameter d1 is greater than the second diameter d2.

The sidewall 1004 includes a first end that couples to the base 1002 and a second, opposing end that defines an opening 1006. Contents are to be inserted through the opening 1006 where the contents are then supported within a reservoir 1005 defined by the sidewall 1004 and the base 1002. The shaftless blending container 1000 further includes a lid 1012, or cap, that is selectively, or removably, attachable to the second end of the sidewall 1004 to maintain a sanitary environment within the reservoir 1005 and/or to prevent the contents stored within the shaftless blending container 1000 from leaking, or otherwise escaping, out of the opening 1006, for example.

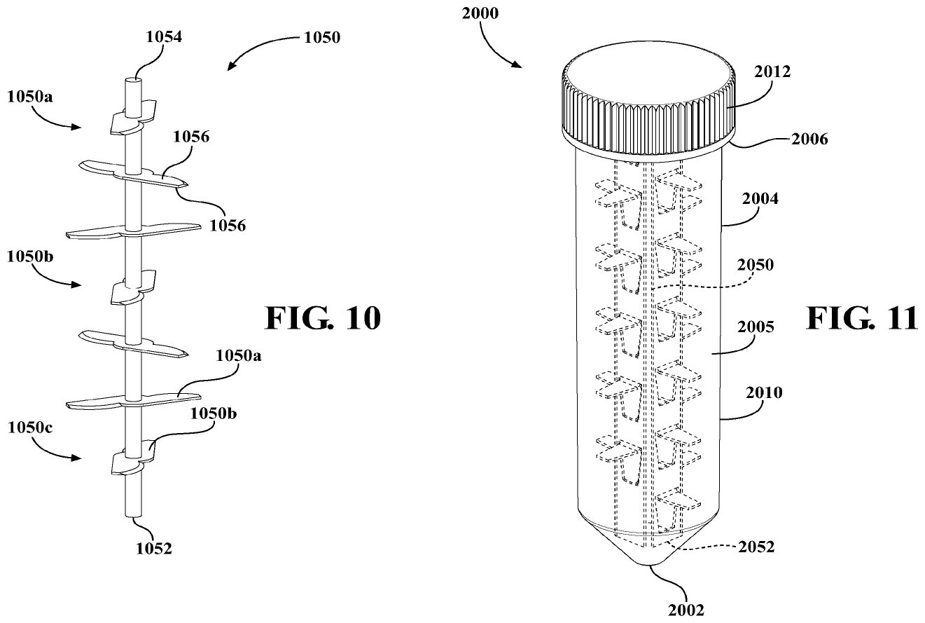

As shown in FIGS. 9 and 10, a mandrel 1050 is selectively positionable in the reservoir 1005 of the shaftless blending container 1000. In various instances, the mandrel 1050 is removably positioned within the reservoir 1005. In other instances, the mandrel 1050 is fixed within the reservoir 1005. In various instances, the mandrel 1050 symmetrically extends along a central axis of the shaftless blending container 1000. The mandrel 1050 can be secured to the shaftless blending container 1000 in numerous manners. For example, a first end 1052 of the mandrel 1050 is located adjacent the base 1002 of the shaftless blending container 1000 when then mandrel 1050 is inserted therein. The first end 1052 can be sized, or otherwise include a geometry, so as to form a press-fit engagement with the reservoir 1005 adjacent the base 1002. Stated another way, when the first end 1052 is closely positioned adjacent the base 1002, an interference fit between the base 1002 and the first end 1052 is created such that the mandrel 1050 is secured in an upright configuration. The presence of the interference fit, or press-fit, prevents the mandrel 1050 from becoming displaced as the contents of the shaftless blending container 1000 are being mixed and/or blended, for example.

Alternatively and/or additionally, the mandrel 1050 can be coupled to the shaftless blending container 1000 via the lid 1012 of the shaftless blending container 1000. For example, the lid 1012 of the shaftless blending container 1000 can include a recess sized to receive a second end 1054 of the mandrel therein. The second end 1054 of the mandrel 1050 can be secured within the recess by a press-fit and/or a threaded engagement, for example. The mandrel 1050 can further be secured to the lid 1012 of the shaftless blending container 1000 by an adhesive or any other suitable coupling mechanism. In other instances, the mandrel 1050 is integrally formed with the lid 1012, for example. Stated another way, the mandrel 1050 and the lid 1012 can be manufactured as one individual component.

In various instances, the base 1002 of the shaftless blending container 1000 comprises a protrusion extending from the base 1002 into the reservoir 1005. The protrusion is sized to receive, or otherwise support, at least a portion of the mandrel 1050 thereon. Stated another way, the mandrel 1050 is secured in its upright configuration by being press-fit, or otherwise coupled, to the protrusion extending from the base 1002 of the shaftless blending container 1000.

In various instances, the mandrel 1050 is coupled to the shaftless blending container 1000 prior to the addition of the contents therein. In other instances, the mandrel 1050 is coupled to the shaftless blending container 1000 after the contents are placed therein.

The mandrel 1050 includes one or more blades 1055a, 1055b coupled thereto to assist in blending and/or mixing the contents stored within the shaftless blending container 1000. The blades 1055a, 1055b can be secured to the mandrel 1050 in any suitable manner. For example, the blades 1055a, 1055b can be integrally formed with the mandrel 1050. In various instances, the one or more blades 1055a, 1055b can be tack welded in position to the mandrel 1050. In various instances, a throughhole can be defined in the blades 1055a, 1055b, to allow the blades 1055a, 1055b to be slid onto the mandrel 1050. Stated another way, the one or more blades 1055a, 1055b are slidably received on the mandrel 1050. In such instances, the mandrel 1050 is received within the throughhole of each blade. In such instances, the mandrel 1050 can be threaded, and the one or more blades 1055a, 1055b can be secured in place with a jam nut, for example. Alternatively, the mandrel 1050 can be smooth, and the throughholes of the one or more blades 1055a, 1055b can be sized to closely receive the mandrel 1050 therein, thereby forming an interference fit with the mandrel 1050. In various instances, the one or more blades 1055a, 1055b are secured, or otherwise fixed, in a predetermined position. Stated another way, the one or more blades 1055a, 1055b do not radially move with respect to one another and/or the mandrel 1050. In other instances, the one or more blades 1055a, 1055b are free to rotate about the mandrel 1050.

In various instances, the one or more blades 1055a, 1055b extend along an entire length of the mandrel 1050 extending between the base 1002 of the shaftless blending container 1000 and the opening 1006. In other instances, the one or more blades 1055a, 1055b extend along only a portion of the length of the mandrel 1050, such as a bottom portion 1050c located adjacent the base, an upper portion 1050a located adjacent the opening 1006, and/or a middle portion 1050b located in between the bottom portion 1050c and the upper portion 1050a. Furthermore, the one or more blades 1055a, 1055b can be symmetrically spaced along the length of the mandrel 1050. In other instances, the one or more blades 1055a, 1055b can be asymmetrically spaced along the length of the mandrel 1050.

As shown in FIGS. 9 and 10, the one or more blades 1055a, 1055b can be positioned on the mandrel 1050 in different orientations. For example, the one or more blades 1055a, 1055b are not aligned with one another. Stated another way, the one or more blades 1055a, 1055b are extend in different radial orientations, or directions, from the mandrel 1050, for example. In other instances, the one or more blades 1055a, 1055b can be aligned with one another. In such instances, the one or more blades 1055a, 1055b extend in the same radial orientation, or direction, from the mandrel 1050. In still other instances, a first set of the one or more blades 1055a, 1055b can be aligned with one another, and a second set of the one or more blades 1055a, 1055b can be aligned with one another.

The one or more blades 1055a, 1055b extend a distance toward the sidewall 1004 from the mandrel 1050. In various instances, the one or more blades 1055a, 1055b extend a distance toward the sidewall 1004 where the one or more blades 1055a, 1055b are adjacent the sidewall 1004, but do not touch, or otherwise contact the sidewall 1004. In such instances, contents from within the shaftless blending container 1000 cannot pass between the one or more blades 1055a, 1055b and the sidewall 1004. In other instances, the one or more blades 1055a, 1055b extend a distance toward the sidewall 1004 that allows for contents to pass therebetween. In various instances, the one or more blades 1055a, 1055b extend a combination of distances toward the sidewall 1004.

In use, as the shaftless blending container 1000 is placed on a blending and/or mixing base, such as the base 200, for example, the contents of the shaftless blending container 1000 are moved through the one or more blades 1055a, 1055b of the mandrel 1050, resulting in a blended mixture of the contents. In various instances, the one or more blades 1055a, 1055b include an edge 1056. The edges 1056 can be blunt, so as to not damage the contents of the shaftless blending container 1000 as they are moved through the one or more blades 1055a, 1055b of the mandrel 1050. Stated another way, the blunt edges 1056 of the one or more blades 1055a, 1055b do not cut, or otherwise separate, individual contents within the shaftless blending container 1000. The blunt edges 1056 instead serve to produce a mixture of the individual contents stored within the shaftless blending container 1000. Additionally and/or alternatively, one or more edge 1056 can be sharpened, so as to cut through contents of the shaftless blending container 1000 as the contents come into contact with the one or more blades 1055a, 1055b. The sharp edges 1056 can be sharpened to a degree that allows for the one or more blades 1055a, 1055b to slice through the contents without destroying, or otherwise compromising, an integrity of the contents of the shaftless blending container 1000. In various instances, the one or more blades 1055a, 1055b can include edges 1056 that are blunt, or otherwise dull. In other instances, the one or more blades 1055a, 1055b can include edges 1056 that are sharpened. In still other instances, the one or more blades 1055a, 1055b can include edges 1056 that are a combination of sharpened and dull. More specifically, a first edge can be sharp while a second edge can be dull.

The mandrel 1050 and/or the one or more blades 1055a, 1055b can be made of a metal material, such as stainless steel, for example. In various instances, the mandrel 1050 and/or the one or more blades 1055a, 1055b are made of a plastic material. However, any material substantial, or strong, enough to blend and/or mix the contents of the shaftless blending container are envisioned. Such material is substantial, or strong, enough if the mandrel 1050 and/or the one or more blades 1055a, 1055b are able to produce a desired blended product without losing structural integrity by breaking, for example. In various instances, the mandrel 1050 and/or the one or more blades 1055a, 1055b are intended to be single-use, or otherwise disposable, products. In other instances, the mandrel 1050 and/or the one or more blades 1055a, 1055b are envisioned to be sterilized and reused for multiple uses.

FIG. 11 shows a shaftless blending container 2000, similar in many respects to the shaftless blending container 1000. In various instances, the shaftless blending container 2000 can be a test tube or a centrifuge tube, for example. The shaftless blending container 2000 includes a body 2010 defined by a base 2002 and a sidewall 2004 extending from the base 2002. In various instances, an interface between the sidewall 2004 and the base 2002 is continuous. Stated another way, the sidewall 2004 and the base 2002 are integrally formed with one another, and no seams exist between the two components. In other instances, a seam exists between the sidewall 2004 and the base 2002. In at least one instance, the base 2002 of the shaftless blending container 2000 may be hermetically sealed. Similar to the base 1002, in various instances, the base 2002 is tapered.

The sidewall 2004 includes a first end that couples to the base 2002 and a second, opposing end that defines an opening 2006. Contents are to be inserted through the opening 1006 where the contents are then supported within a reservoir 2005 defined by the sidewall 2004 and the base 2002. The shaftless blending container 2000 further includes a lid 2012, or cap, that is selectively, or removably, attachable to the second end of the sidewall 2004 to maintain a sanitary environment within the reservoir 2005 and/or to prevent the contents stored within the shaftless blending container 2000 from leaking, or otherwise escaping, out of the opening 2006, for example.

As shown in FIGS. 11-13, a blade column 2050 is selectively positionable in the reservoir 2005 of the shaftless blending container 2000. In various instances, the blade column 2050 is removably positioned in the reservoir 2005. In other instances, the blade column 2050 is fixed within the reservoir 2005. In various instances, the blade column 2050 symmetrically extends along a central axis of the shaftless blending container 2000. The blade column 2050 can be secured to the shaftless blending container 2000 in any manner. For example, a first end 2052 of the blade column 2050 is located adjacent the base 2002 of the shaftless blending container 2000 when then blade column 2050 is inserted therein. The first end 2052 can be sized, or otherwise include a geometry, so as to form a press-fit engagement with the reservoir 2005 adjacent the base 2002. Stated another way, when the first end 2052 is closely positioned adjacent the base 2002, an interference fit between the base 2002 and the first end 2052 is created such that the blade column 2050 is secured in an upright configuration. In such instances, the first end 2052 of the blade column 2050 can be tapered so as to mimic the geometry of the base 2002. The presence of the interference fit, or press-fit, prevents the blade column 2050 from becoming displaced as the contents of the shaftless blending container 2000 are being mixed and/or blended, for example.

Alternatively and/or additionally, the blade column 2050 can be coupled to the shaftless blending container 2000 by the lid 2012 of the shaftless blending container 2000. For example, the lid 2012 of the shaftless blending container 2000 can include a recess sized to receive a second end 2054 of the mandrel therein. The second end 2054 of the blade column 2050 can be secured within the recess by a press-fit and/or a threaded engagement, for example. The blade column 2050 can further be secured to the lid 2012 of the shaftless blending container 2000 by an adhesive or any other suitable coupling mechanism.

In various instances, the blade column 2050 is coupled to the shaftless blending container 2000 prior to the addition of the contents therein. In other instances, the blade column 2050 is coupled to the shaftless blending container 2000 after the contents are placed therein.

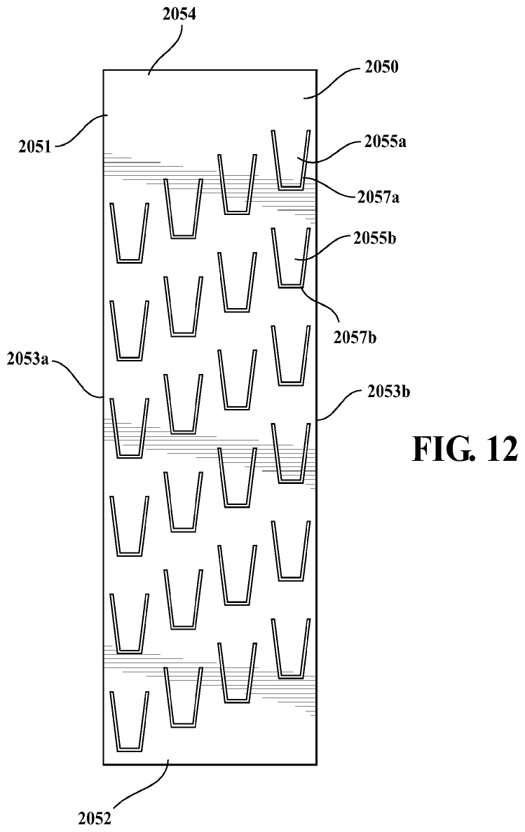

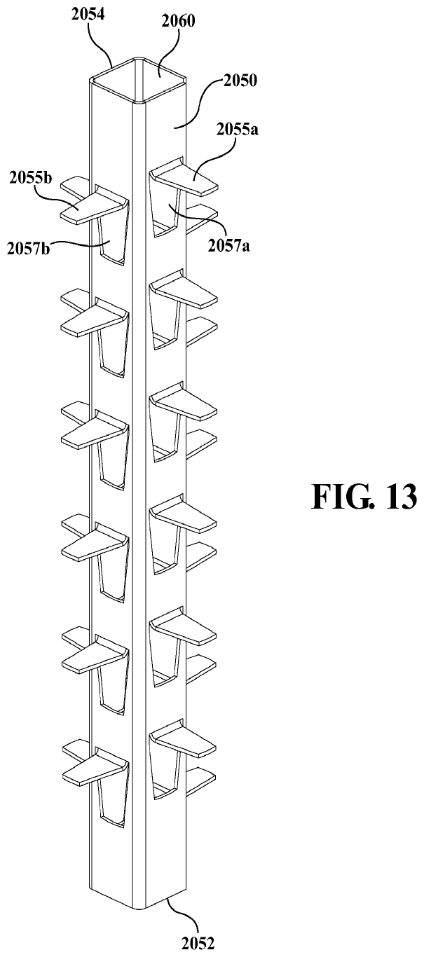

The blade column 2050 is manufactured as a single piece. More specifically, the blade column 2050 is manufactured by stamping a piece of sheet metal, for example. The blade column 2050, in an unfolded configuration, is shown in FIG. 12. The blade column 2050 includes a first sidewall 2053a and a second sidewall 2053b extending between the first end 2052 and the second end 2054. The first sidewall 2053a and the second sidewall 2053b are to be coupled, or otherwise joined, together to form a folded configuration of the blade column 2050, as shown in FIG. 13. In various instances, the first sidewall 2053a and the second sidewall 2053b are welded, or otherwise fused, together; however any suitable coupling mechanism including adhesives is envisioned. In other instances, the first sidewall 2053a and the second sidewall 2053b are not physically coupled together. Instead, the first sidewall 2053a and the second sidewall 2053b are merely brought in close contact with one another, for example.

The blade column 2050 includes one or more tabs 2055a, 2055b stamped into a body 2051 of the blade column 2050. The one or more tabs 2055a, 2055b are defined by an aperture 2057a, 2057b, or recess that extends in a U- or V-arrangement, for example; however, the aperture 2057a, 2057b can be shaped in any suitable manner so as to form a desirable blade shape. Notably, an aperture 2057a, 2057b extending in a U-arrangement may provide a blunt edge, while an aperture 2057a, 2057b extending in a V-arrangement may provide a sharp edge, for example. While FIGS. 12 and 13 depict the one or more tabs 2055a, 2055b defined facing toward the first end 2052 of the blade column 2050, the one or more tabs 2055a, 2055b can be defined in any other configuration, such as facing toward the second end 2054 of the blade column, facing toward the first sidewall 2053a, facing toward the second sidewall 2054a, or any combination thereof.

The one or more tabs 2055a, 2055b can be defined an entire length of the blade column 2050 extending between the first end 2052 and the second end 2054. In other instances, the one or more tabs 2055a, 2055b extend along only a portion of the length of the blade column 2050, such as a bottom portion located adjacent the first end 2052, an upper portion located adjacent the second end 2054, and/or a middle portion located in between the bottom portion and the upper portion. Furthermore, the one or more tabs 2055a, 2055b can be symmetrically spaced along the length of the blade column 2050. In other instances, the one or more tabs 2055a, 2055b can be asymmetrically spaced along the length of the blade column 2050.

As shown in FIGS. 12 and 13, for example, the one or more tabs 2055a, 2055b are evenly distributed along four vertical columns. Stated another way, when the first sidewall 2053a of the blade column 2050 is folded toward the second sidewall 2053b, four vertical columns are visually defined. A first vertical column includes a first number of tabs, a second vertical column includes a second number of tabs, a third column includes a third number of tabs, and a fourth column includes a fourth number of tabs. The first number is the same as the second number, the third number, and the fourth number. In other instances, the one or more tabs 2055a, 2055b can be present in different quantities along vertical columns.

Furthermore, as shown in FIGS. 12 and 13, for example, the one or more tabs 2055a, 2055b are not horizontally aligned. Stated another way, a first tab defined in the first vertical column is defined a first distance from the second end 2054 of the blade column 2050, wherein the first tab is the closest tab to the second end 2054 from the first vertical column. A second tab defined in the second vertical column is defined a second distance from the second end 2054 of the blade column 2050, wherein the second tab is the closest tab to the second end 2054 from the second vertical column. The first distance and the second distance are different. Such pattern extends through the third vertical column and the fourth vertical column. In other instances, the one or more tabs 2055a, 2055b can be horizontally aligned with one another.

In the folded configuration, as shown in FIG. 13, a central passage 2060 is defined through the center of the blade column 2050. The one or more tabs 2055a, 2055b are to be folded, or otherwise moved, into an upright configuration so that the tabs 2055a, 2055b extend substantially perpendicular to the body 2051 of the blade column 2050. In various instances, the tabs 2055a, 2055b extend to a degree less than perpendicular with respect to the body 2051 of the blade column 2050 but greater than zero degrees so as to not remain flush with the body 2051. In their folded, upright configuration, the one or more tabs 2055a, 2055b expose the central passage 2060 defined through the center of the blade column 2050. If left exposed, or otherwise open, contents of the shaftless blending container 2000 can become stuck within the central passage 2060. To prevent the contents of the shaftless blending container 2000 from flowing, or otherwise traveling, in to the central passage 2060 defined by the blade column 2050, an additional blocking member can be inserted through the central passage 2060. Such a blocking member can be sized so as to be closely received within the central passage 2060, thereby preventing the contents of the shaftless blending container 2000 from being able to flow into, or otherwise access, the central passage 2060. Such blocking member need not be solid and can be made of any suitable material.

As discussed herein with respect to FIG. 5, for example, when a shaftless blending container, such as the shaftless blending containers 100, 1000, 2000, is used with conventional blending machines, a user maintains contact with the shaftless blending container during a blending and/or mixing process. Such constant, or maintained, user contact is desirable to ensure the shaftless blending container remains in a desired orientation, or otherwise remains in sufficient contact, with the mixing platform of the blending machine. Notably, conventional blending machines fail to include a dedicated housing sized to receive, or otherwise support, the shaftless blending container therein. Without contact user contact, the shaftless blending container would likely fall over, for example, thereby disrupting the blending and/or mixing process.

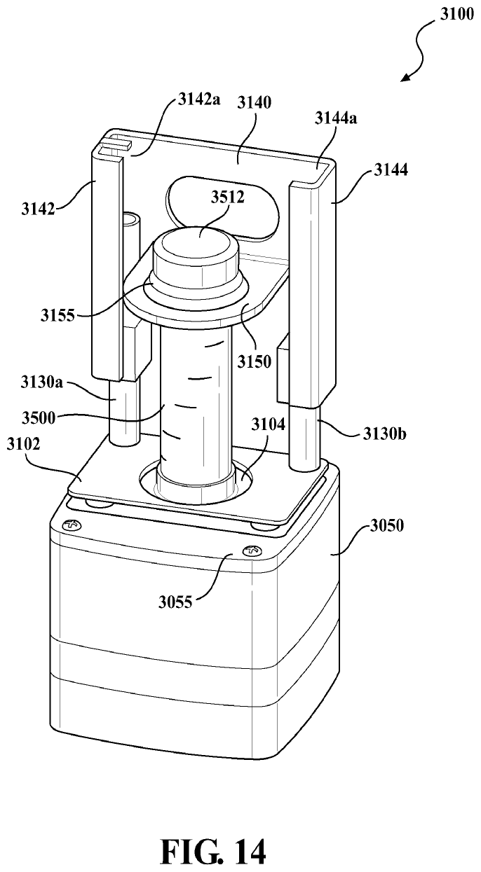

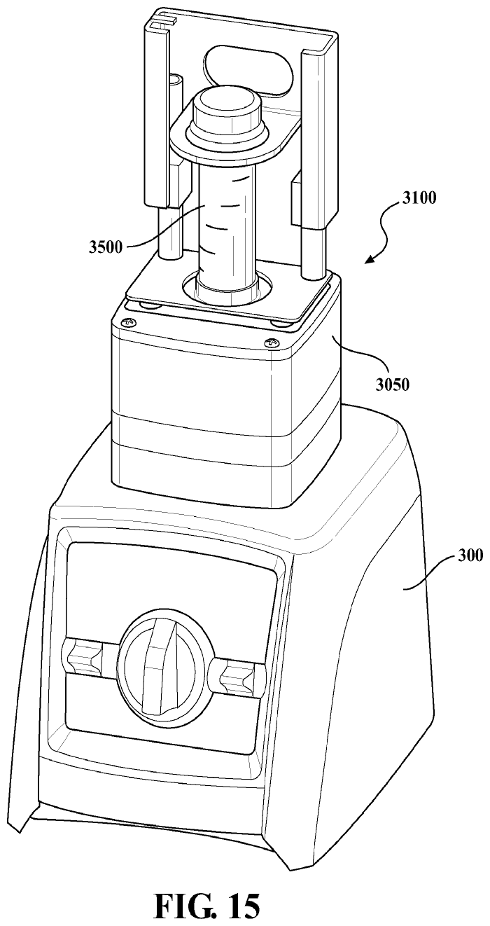

FIGS. 14 and 15 show an attachment mechanism 3100 for selective coupling to a blending machine base 3000 to support a shaftless blending container 3500 thereon without a need for user support. The attachment mechanism 3100 includes an adapter 3050 for converting an output of a motor housed within the blending machine base 3000 into orbital motion. The adapter 3050 includes a mixing platform 3055 for contact with a shaftless blending container. The attachment mechanism 3100 further includes a base 3102 to be positioned adjacent a mixing platform 3055 of the adapter 3050. The base 3102 of the attachment mechanism 3100 includes a throughhole 3104 defined therethrough. The throughhole 3104 is sized to receive a base of the shaftless blending container 3500 therethrough and permit the base of the shaftless blending container 3500 to contact the mixing platform 3055 of the adapter 3050.

One or more support columns 3130a, 3130b extend from the base 3102 of the attachment mechanism 3100 in a direction away from the adapter 3050. The attachment mechanism 3100 further includes a backboard 3140 having a first side 3142 and a second side 3144. A first support column 3130a is sized to be slidingly, or otherwise movably, received in a slot 3142a defined on the first side 3142 of the backboard 3140. Similarly, a second support column 3130b is sized to be slidingly, or otherwise movably, received in a slot 3144a defined on the second side 3144 of the backboard 3140. Such a sliding engagement allows for the attachment mechanism 3100 to support shaftless blending containers of different sizes, and more specifically shaftless blending containers having different heights. For example, the backboard 3140 can be slid closer toward the base 3102 of the attachment mechanism 3100 to support a short shaftless blending container therein. The backboard 3140 can be slid away from the base 3102 of the attachment mechanism 3100 to support a tall shaftless blending container therein.

The backboard 3140 of the attachment mechanism 3100 includes a lid engagement portion 3150. The lid engagement portion 3150 extends substantially horizontal from the backboard 3140. Stated another way, the lid engagement portion 3150 extends substantially parallel with the base 3102 of the attachment mechanism 3100. The lid engagement portion 3150 includes a throughhole 3155 defined therethrough. The throughhole 3155 is sized to receive a body of the shaftless blending container 3500 therethough while preventing a lid 3512 of the shaftless blending container 3500 from being able to pass therethough. Stated another way, the throughhole 3155 is large enough to allow the body of the shaftless blending container 3500 to extend therethrough but small enough to prevent the lid 3512 of the shaftless blending container 3500 to extend therethrough. The lid 3512 of the shaftless blending container 3500 has a lid diameter that is greater than a diameter of the throughhole 3155. The attachment mechanism 3100 thereby provides support sufficient to maintain the shaftless blending container 3500 in an upright configuration while also maintaining suitable contact between the shaftless blending container 3500 and the mixing platform 3055 of the blending machine base 3000.

In various instances, the mixing platform 3055 extends through the throughhole 3104 of the base 3102. In such instances, the mixing platform 3055 can be sized and/or shaped to closely receive the base of the shaftless blending container 3500 therein. In various instances, the lid engagement portion 3150 does not include a throughhole 3155. In such instances, the lid engagement portion 3150 can be shaped to mimic the lid 3512 of the shaftless blending container 3500. In such instances, the lid engagement portion 3150 presses down, such as by spring force, for example, on top of the lid 3512 of the shaftless blending container 3500 to maintain the shaftless blending container 3500 in a desired orientation.

The shaftless blending containers described herein may be disposable. For example, the shaftless blending containers may be single-use containers.

The shaftless blending containers described herein may be blow-molded. In various instances, a shaftless blending container may be blow-molded triton. The shaftless blending containers may also be injection-molded, etc. The shaftless blending container may be formed of any desirable plastic or other material as may be used in the art, also including metals and coated paper composites. It is further noted that the container may be dishwasher safe, autoclavable, and/or otherwise sterilizable.

### EXAMPLES

Example 1—A blending container is disclosed. The blending container includes a body including a continuous base and a sidewall extending from the continuous base. The continuous base and the sidewall define a reservoir for receiving contents therein. The blending container further includes a blade positioned on or adjacent to the sidewall of the body.

Example 2—The blending container of Example 1, wherein the base is closed.

Example 3—The blending container of any of Examples 1 and 2, wherein the base is hermetically sealed.

Example 4—The blending container of any of Examples 1-3, wherein at least a portion of the blade extends from the sidewall of the body.

Example 5—The blending container of any of Examples 1-4, further including a lid removably coupled to the body.

Example 6—The blending container of any of Examples 1-5, further including a mandrel extending into the reservoir, wherein the blade is coupled to the mandrel.

Example 7—The blending container of Example 6, wherein the blade is welded to the mandrel.

Example 8—The blending container of Example 6, wherein the blade includes a throughhole defined therethrough, wherein the blade is slidably received on the mandrel, and wherein the mandrel is extends through the throughhole of the blade.

Example 9—The blending container of any of Examples 1-5, further including a blade column extending into the reservoir, wherein the blade is defined on the blade column.

Example 10—The blending container of Example 9, wherein the blade is stamped into the blade column.

Example 11—The blending container of any of Examples 1-10, wherein the blade is fixed in a predetermined position within the blending container.

Example 12—The blending container of any of Examples 1-11, wherein the blade includes a blunt edge.

Example 13—The blending container of any of Examples 1-12, wherein the blade includes a sharp edge.

Example 14—The blending container of any of Examples 1-13, further including a second blade positioned adjacent the sidewall of the body.

Example 15—A blending container is disclosed. The blending container includes a body including a closed base and a sidewall extending from the closed base. The closed base and the sidewall define a reservoir for receiving contents therein, wherein the sidewall includes an interior surface. The blending container further includes a plurality of blades positioned adjacent to the interior surface of the sidewall.

Example 16—The blending container of Example 15, wherein the plurality of blades are positioned on the interior surface of the sidewall.

Example 17—The blending container of any of Examples 15 and 16, wherein at least a portion of each of the plurality of blades is embedded in the sidewall of the body.

Example 18—The blending container of Example 15, further including a mandrel extending into the reservoir, wherein the plurality of blades are coupled to the mandrel.

Example 19—The blending container of Example 18, further including a lid removably couplable to the body, wherein the mandrel is coupled to the lid.

Example 20—The blending container of any of Examples 18 and 19, wherein the mandrel forms an interference fit with the base of the body.

Example 21—The blending container of Example 15, further including a blade column extending into the reservoir, wherein the plurality of blades are stamped into the blade column.

Example 22—The blending container of Example 21, further including a lid removably couplable to the body, wherein the blade column is coupled to the lid.

Example 23—The blending container of any of Examples 21 and 22, wherein the blade column forms an interference fit with the base of the body.

Example 24—The blending container of any of Examples 21-23, wherein a central passage is defined through a center of the blade column.

Example 25—The blending container of Example 24, further including a blocking member received in the central passage to prevent the contents of the blending container from flowing into the central passage.

Example 26—The blending container of any of Examples 15-25, wherein the plurality of blades are fixed in a predetermined position within the blending container.

Example 27—The blending container of any of Examples 15-26, wherein the plurality of blades are positioned equidistant around a circumference of the blending container.

Example 28—The blending container of any of Examples 15-27, wherein the plurality of blades are positioned at sequential heights along a length of the blending container.

Example 29—The blending container of any of Examples 15-28, wherein the base comprises a frustoconical, conical, rounded, or tapered shape.

Example 30—A blending assembly is disclosed. The blending assembly includes a blending container including a base, the base being closed, and a sidewall extending from the base. The base and the sidewall define a reservoir to support contents therein. The blending container further includes a plurality of blades positioned adjacent the sidewall of the body. The blending assembly further includes an attachment mechanism for supporting the blending container in a desired orientation during a blending process.

Example 31—The blending assembly of Example 30, wherein the attachment mechanism includes an adapter comprising a mixing platform, and wherein the base of the blending container is to contact the mixing platform during the blending process.

Example 32—The blending assembly of Example 31, wherein the adapter is for converting an output of a motor into an orbital motion.

Example 33—A blending container is disclosed. The blending container includes a body including a closed base and a sidewall extending from the closed base. The closed base and the sidewall define a reservoir for receiving contents therein. The blending container further includes a plurality of blades, wherein each of the plurality of blades extend into the reservoir from the sidewall of the body.

Example 34—The blending container of Example 33, wherein the plurality of blades are at least partially embedded in the sidewall of the body.

Example 35—A blending container is disclosed. The blending container includes a body including a closed base and a sidewall extending from the closed base. The closed base and the sidewall define a reservoir for receiving contents therein. The blending container further includes a mandrel positioned in the reservoir of the body, the mandrel including a plurality of blades positioned thereon.

Example 36—The blending container of Example 35, wherein the plurality of blades extend toward the sidewall from the mandrel Example 37—The blending container of any of Examples 35 and 36, wherein the plurality of blades are positioned adjacent the sidewall of the body.

Example 38—The blending container of any of Examples 35-37, wherein the plurality of blades are welded onto the mandrel.

Example 39—The blending container of any of Examples 35-37, wherein the plurality of blades are integrally formed with the mandrel.

Example 40—The blending container of any of Examples 35-37, wherein the plurality of blades are slidingly received on the mandrel.

Example 41—The blending container of any of Examples 35-41, wherein the mandrel forms an interference fit with the base of the body.

Example 42—The blending container of any of Examples 35-41, further including a lid removably coupled to the body, wherein the mandrel is coupled to the lid.

Example 43—A blending container is disclosed. The blending container includes a body including a closed base and a sidewall extending from the closed base. The closed base and the sidewall define a reservoir for receiving contents therein, wherein the sidewall includes an interior surface. The blending container further includes a blade column positioned in the reservoir of the body, the blade column including a plurality of blades defined thereon.

Example 44—The blending container of Example 43, wherein the plurality of blades are stamped into the blade column.

Example 45—The blending container of any of Examples 43 and 44, wherein the blade column forms an interference fit with the base of the body.

Example 46—The blending container of any of Examples 43-45, wherein a central passage is defined through a center of the blade column.

Example 47—The blending container of Example 46, further including a blocking member received in the central passage to prevent the contents of the blending container from flowing into the central passage.

In view of the above, it should now be understood that at least some embodiments of the present disclosure are directed to shaftless blending containers including one or more blades positioned within a reservoir defined by a base and a sidewall of a particular shaftless blending container. In various instances, the one or more blades are positioned adjacent the sidewall of the particular shaftless blending container. The one or more blades can be supported within the reservoir of the shaftless blending container in various manners, such as an individual blade being embedded within the sidewall, a mandrel, extending into the reservoir, having the one or more blades positioned thereon, and/or a blade column, extending into the reservoir, having the one or more blades defined thereon, for example.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It is to be understood that other embodiments may be utilized, and structural and functional changes may be made without departing from the scope of the present disclosure. Moreover, features of the embodiments may be combined, switched, or altered without departing from the scope of the present teachings, e.g., features of each disclosed embodiment may be combined, switched, or replaced with features of the other disclosed embodiments. In this disclosure, numerous specific details provide a thorough understanding of the subject disclosure. It should be understood that aspects of this disclosure may be practiced with other embodiments not necessarily including all aspects described herein, etc. As such, the description is presented by way of illustration and does not limit the various alternatives and modifications that may be made to the illustrated embodiments and still be within the spirit and scope of the present disclosure.

1. A blending container, comprising:
a body comprising:
a continuous base; and
a sidewall extending from the continuous base, the continuous base and the sidewall defining a reservoir for receiving contents therein; and
a blade positioned on or adjacent to the sidewall of the body.

2-3. (canceled)

4. The blending container of claim 1, wherein at least a portion of the blade extends from the sidewall of the body.

5. The blending container of claim 1, further comprising a lid removably coupled to the body.

6. The blending container of claim 1, further comprising a mandrel extending into the reservoir, wherein the blade is coupled to the mandrel.

7. (canceled)

8. The blending container of claim 6, wherein the blade comprises a throughhole defined therethrough, wherein the blade is slidably received on the mandrel, and wherein the mandrel extends through the throughhole of the blade.

9. The blending container of claim 1, further comprising a blade column extending into the reservoir, wherein the blade is defined on the blade column.

10. (canceled)

11. The blending container of claim 1, wherein the blade is fixed in a predetermined position within the blending container.

12-14. (canceled)

15. A blending container, comprising:
a body comprising:
a closed base; and
a sidewall extending from the closed base, the closed base and the sidewall defining a reservoir for receiving contents therein, wherein the sidewall comprises an interior surface; and
a plurality of blades positioned adjacent to the interior surface of the sidewall.

16. The blending container of claim 15, wherein the plurality of blades are positioned on the interior surface of the sidewall.

17. The blending container of claim 15, wherein at least a portion of each of the plurality of blades is embedded in the sidewall of the body.

18. The blending container of claim 15, further comprising a mandrel extending into the reservoir, wherein the plurality of blades are coupled to the mandrel.

19. The blending container of claim 18, further comprising a lid removably couplable to the body, wherein the mandrel is coupled to the lid.

20. (canceled)

21. The blending container of claim 15, further comprising a blade column extending into the reservoir, wherein the plurality of blades are stamped into the blade column.

22-25. (canceled)

26. The blending container of claim 15, wherein the plurality of blades are fixed in a predetermined position within the blending container.

27-34. (canceled)

35. A blending container, comprising:
a body comprising:
a closed base; and
a sidewall extending from the closed base, the closed base and the sidewall defining a reservoir for receiving contents therein; and
a mandrel positioned in the reservoir of the body, the mandrel comprising:
a plurality of blades positioned thereon.

36. The blending container of claim 35, wherein the plurality of blades extend toward the sidewall from the mandrel.

37. The blending container of claim 35, wherein the plurality of blades are positioned adjacent the sidewall of the body.

38. (canceled)

39. The blending container of claim 35, wherein the plurality of blades are integrally formed with the mandrel.

40. The blending container of claim 35, wherein the plurality of blades are slidingly received on the mandrel.

41. (canceled)

42. The blending container of claim 35, further comprising a lid removably coupled to the body, wherein the mandrel is coupled to the lid.

43-47. (canceled)
